(19) United States
(12) Patent Application Publication
(10) Pub. No.: US 2025/0211670 A1
(43) Pub. Date: Jun. 26, 2025

(54) Portable Alarm with Pull Ring Device

(71) Applicant: Donald Murphy, Cape Canaveral, FL (US)

(72) Inventor: Donald Murphy, Cape Canaveral, FL (US)

(21) Appl. No.: 18/901,611

(22) Filed: Sep. 30, 2024

Related U.S. Application Data
(60) Provisional application No. 63/613,099, filed on Dec. 21, 2023.

(51) Int. Cl. H04M 1/72424; H04M 1/04; H04M 1/72409; H04M 1/72412

(52) U.S. Cl. CPC H04M 1/72424; H04M 1/04; H04M 1/724092; H04M 1/72412

(57) ABSTRACT

A portable alarm device is disclosed, which is a portable alarm that is secured to a user's cell phone. The portable alarm device comprises a base component secured to the back of a user's cell phone. The grip member component is typically rounded in shape and comprises a rectangular component which mates with the base component and secures the device to a user's cell phone. The grip member component comprises a built-in self-defense alarm and speaker, that is rechargeable via a USB-C charging port, as needed. Further, the grip member device can be expanded to provide a grip and a kickstand. The grip member component can also comprise a pull ring locking mechanism, a pull ring, a safety chain, and an alarm pin to activate the built-in alarm. Finally, the grip member component is detachable and functions on its own.

### CROSS-REFERENCE TO RELATED APPLICATION

The present application claims priority to, and the benefit of, U.S. Provisional Application No. 63/613,099, which was filed on Dec. 21, 2023, and is incorporated herein by reference in its entirety.

### FIELD OF THE INVENTION

The present invention relates generally to the field of portable alarm devices. More specifically, the present invention relates to a personal alarm which secures to a cell phone and carried in the hand by a user. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in portable alarm devices. Generally, there are self-defense mechanisms which utilize pull tab alarms, but these require users to carry an extra device. Another solution requires a user to use a whistle, but users have to carry it and/or wear it, which can be inconvenient.

Furthermore, emergency response numbers, such as 911, are utilized to provide individuals with a quick and easy way to contact an emergency response center when an emergency situation arises. It is now possible to carry a cellular telephone that allows an emergency caller to contact an emergency response center from practically anywhere. A drawback of known cell phone emergency use includes actuating the alarm by performing multiple actions and actuating an alarm button, which may cause confusion in an emergency situation. Because of the stress often associated with emergency situations, an operator of a smartphone may fail to properly perform the correct actions and actuate the correct button and may therefore fail to summon emergency personnel. Thus, a cell phone personal safety alarm in which the emergency response time is minimized is desired.

Accordingly, there is a demand for an improved portable alarm device that can be attached to a cell phone to provide a self-defense alarm. More particularly, there is a demand for a portable alarm device that utilizes a pull ring to sound the alarm quickly to get help, as needed.

Therefore, there exists a long felt need in the art for a portable alarm device that provides users with a personal alarm that can be separated from a cell phone and used as an independent device. There is also a long felt need in the art for a portable alarm device that allows a user to carry the alarm in their hand. Further, there is a long felt need in the art for a portable alarm device that can be secured to a cell phone. Moreover, there is a long felt need in the art for a device that can be used as a phone grip to hold a cell phone while in use. Further, there is a long felt need in the art for a portable alarm device that can be used as a kickstand to hold up your cell phone while viewing it. Finally, there is a long felt need in the art for a portable alarm device that is easily recharged, as needed.

The subject matter disclosed and claimed herein, in one embodiment thereof, comprises a portable alarm device. The device is a portable alarm which can be secured to a user's cell phone. The portable alarm device comprises a base component that is configured in a rectangular shape with rounded corners. The base component secures to the back of a user's cell phone and acts to accept the back of the grip member component. The grip member component is typically rounded in shape and comprises a rectangular component which mates with the base component and secures the device to a user's cell phone. The grip member component comprises a built-in self-defense alarm and speaker, that is rechargeable via a USB-C charging port, as needed. Further, the grip member device can be expanded to provide a grip and a kickstand. The grip member component can also comprise a pull ring locking mechanism, a pull ring, a safety chain, and an alarm pin to activate the built-in alarm. Finally, the grip member component is detachable and functions on its own.

In this manner, the portable alarm device of the present invention accomplishes all of the forgoing objectives and provides users with a device that can be secured to a user's cell phone. The device is a portable alarm that can be quickly activated via a pull ring. The device can comprise a rechargeable battery.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable alarm device. The device is a portable alarm which can be secured to a user's cell phone. The portable alarm device comprises a base component that secures to the back of a user's cell phone and acts to accept the back of the grip member component. The grip member component mates with the base component and secures the device to a user's cell phone. The grip member component comprises a built-in self-defense alarm and speaker, that is rechargeable via a USB-C charging port, as needed. The grip member component can also comprise a pull ring locking mechanism, a pull ring, a safety chain, and an alarm pin to activate the built-in alarm.

In one embodiment, the portable alarm device is secured to a user's cell phone or detached and used on its own. The portable alarm device allows a user to loop their finger through the pull ring, while still being able to operate the cell phone and can read, watch videos, or stream movies on the cell phone. If a perpetrator tries to grab the cell phone and run off, the pull ring will be removed from the base component and the alarm will immediately go off. Thus, if a perpetrator tries to grab the cell phone and run off, the pull ring will be removed from the base component and the alarm will immediately go off. Whereas the alarm is attached to the user's cell phone now becomes a property alarm. Thus, the perpetrator is more likely to discard or leave behind user's cell phone instead of continuing to flee with user's property while alarm is going off. As a result, the device not only functions as a personal alarm for a user, but may also function as a property alarm if a cell phone is stolen from a user's hand. The device can also be operated one-handed from a belt case or car mount for the cell phone. Further, the device can be separated from the cell phone and used as an independent device that a user merely carries in their hand.

In one embodiment, the portable alarm device comprises a base component that is configured in a rectangular shape with rounded corners but can be any suitable shape as is known in the art. The base component secures to the back of a user's cell phone, smart phone, smart pad, etc. Typically, the base component is adhesively mounted with a removable, pressure-sensitive adhesive at a back or rear planar wall of the cell phone or its protective case. Specifically, the base component is attached to a back panel of a cell phone or other portable electronic device, or to a back panel of a protective and/or ornamental case installed on the electronic device. The protective case is optional, as the base component can be secured directly to the cell phone, itself. The base component can be any suitable shape and size as is known in the art, as long as the base component acts to secure a grip member component to the cell phone for use. Specifically, the base component comprises indentations or a channel to receive the rectangular part of the grip member component. Thus, the rectangular part is slid into or press fit and secured via an interference fit to the base component.

In one embodiment, the portable alarm device comprises a grip member component. The grip member component is typically rounded in shape and comprises a rectangular component which mates with the base component and releasably secures the device to a user's cell phone, as discussed supra. Further, the rounded part of the grip member component comprises a built-in self-defense alarm and speaker, as well as any required circuitry and wiring needed for the alarm and speaker. Additionally, the grip member component can be extended outward via an accordion spring or other suitable extending means. This allows a user to use the extended grip member component as a gripping means positioned between their fingers (i.e., similar to a pop socket), or as a kickstand to prop up the cell phone on a table or other surface to watch movies or videos or read from the cell phone. Specifically, the kickstand can support the cell phone at an angle against a support surface. In use as a stand, an edge of the cell phone and a portion of the kickstand rest against a support surface supporting the rest of the cell phone above the support surface. Thus, the grip member component in an extended position, can be positioned and dimensioned to support the cell phone in a landscape orientation and/or a portrait orientation.

In one embodiment, the grip member component comprises a movable, circular pull ring, which is mounted on the grip member component and secured via a pull ring locking mechanism. The pull ring locking mechanism would comprise at least one notch, which would act to secure the pull ring in place via an interference fit. Specifically, the pull ring is received in a recess of the pull ring locking mechanism and surrounds the center circular part of the grip member component. The at least one notch would then act to secure the pull ring in place within the pull ring locking mechanism. Further, the at least one notch can be released via a user's finger or nail inserted under the notch to pivot or flip the pull ring free. Once free. the user's finger is then inserted into a central opening of the pull ring, so that the pull ring may serve as a holder for the portable alarm device and attached cell phone, which also prevents the cell phone from falling out of one's hand or grasp during cell phone use.

In one embodiment, the pull ring is secured to a safety chain. The safety chain can be any suitable size and length as is known in the art, depending on the needs and/or wants of a user. The safety chain can be secured via a loop, weld, etc., to the pull ring. Further, the safety chain can be manufactured of any suitable material, such as rope, twine, wire, chain, etc.

In one embodiment, the safety chain is then secured to an alarm pin. The alarm pin is communicatively coupled to the speaker and built-in self-defense alarm. The user may activate the speaker and alarm by pulling the pull ring away from the device, which will remove the alarm pin and sound the alarm. Specifically, the alarm pin is a non-conductive component positioned between two conductive components. Thus, once the alarm pin (i.e., the non-conductive component) is removed, the two conductive components are able to touch, which closes the circuit and sounds the alarm through the speakers.

In one embodiment, the rounded part of the grip member component contains a built-in self-defense alarm, a rechargeable battery, and a speaker, which are all electrically interconnected in a common circuit. The rounded part of the grip member component may be configured, in one embodiment, with holes through which the speaker broadcasts a loud alarm sound or siren when the alarm pin is removed and the built-in alarm is actuated. In an emergency, the pull ring may be manually pulled outwardly, which removes the alarm pin to actuate the alarm circuit and immediately sounds the alarm. Manually replacing the alarm pin silences the alarm sound or siren.

In one embodiment, the rechargeable battery is recharged via an included USB charging port.

In one embodiment, rather than relying solely on the movement of the pull ring, the rounded part of the grip member component may be configured as a button that, when manually pressed, actuates the alarm circuit and, in turn, sounds the alarm through the speaker to cause the loud alarm sound or siren to be generated. Manually pressing on the button again silences the alarm sound or siren.

In one embodiment, the grip member component is detachable from the base component and functions on its own. A user merely holds the device within their hand and either pulls the pull ring to remove the alarm pin or manually presses the alarm button.

Thus, in accordance with this disclosure, the response time for actuating the portable alarm device is minimized, because the user's finger is already normally located within the pull ring during cell phone use, and there is a little or negligible time delay in actuating the alarm circuit by the user pulling the pull ring and removing the alarm pin, or pressing a button on the grip member component. in an emergency.

In one embodiment, rather than relying solely on the loud siren to draw attention to the user in the event of an emergency. i.e., a medical emergency or a physical attack, the alarm circuit advantageously includes a Bluetooth transceiver to wirelessly communicate with the cell phone's on-board microprocessor or controller and, in turn, with the cell phone's on-board memory. Thus, actuating the alarm circuit by pulling on the pull ring and removing the alarm pin, as described above, generates an electrical alarm signal that automatically wirelessly communicates with the cell phone's controller and activates an auto-dial call to e-911 (enhanced 911) to notify law enforcement, medical personnel, and/or to any pre-designated individuals or responders whose contact numbers have been entered into and stored in the cell phone's memory. The auto-dial feature need not be accompanied with a loud siren. because, in some emergency situations, it may be desirable just to generate a silent alarm.

In one embodiment, the portable alarm device can be used with portable electronic devices other than a cell phone, such as tablet computers or e-readers, etc.

In use, the portable alarm device is secured to the back of a user's cell phone and a user disengages the pull ring from the grip member component and inserts one or more fingers through the pull ring to securely hold the cell phone and device for use. Thus, if the user's cell phone is taken, the pull ring around a user's finger pulls the safety chain to remove the alarm pin and sound the alarm.

In other embodiments, the portable alarm device can have another shape. The portable alarm ring can also include decorative elements, designs, patterns, etc.

In yet another embodiment, the portable alarm device comprises a plurality of indicia.

In yet another embodiment, a method of quickly emitting a personal alarm as needed is disclosed. The method includes the steps of providing a portable alarm device comprising a base component with a grip member component. The method also comprises securing the base component to a back of a user's cell phone. Further, the method comprises attaching the grip member component to the base component. The method also comprises positioning a user's finger through a pull ring with attached safety chain. Finally, the method comprises pulling off the safety chain via the pull ring to sound the alarm, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the portable alarm device of the present invention showing the front of the device in accordance with the disclosed architecture;

FIG. 2 illustrates a perspective view of one embodiment of the portable alarm device of the present invention showing the back of the device in accordance with the disclosed architecture;

FIG. 3 illustrates a perspective view of one embodiment of the portable alarm device of the present invention showing the safety chain connected to the pull ring in accordance with the disclosed architecture;

FIG. 4 illustrates a perspective view of one embodiment of the portable alarm device of the present invention showing the on/off button in accordance with the disclosed architecture;

FIG. 5 illustrates a perspective view of one embodiment of the portable alarm device of the present invention showing the safety chain connected to the device in accordance with the disclosed architecture;

FIG. 6 illustrates a perspective view of one embodiment of the portable alarm device of the present invention showing a side view of the safety chain connected to the device in accordance with the disclosed architecture;

FIG. 7 illustrates a perspective view of one embodiment of the portable alarm device of the present invention showing the pull ring, safety chain and pull ring locking mechanism in accordance with the disclosed architecture;

FIG. 8 illustrates a perspective view of one embodiment of the portable alarm device of the present invention showing the device attached to the base component in accordance with the disclosed architecture;

FIG. 9 illustrates a perspective view of one embodiment of the portable alarm device of the present invention showing the safety chain connected to the device in accordance with the disclosed architecture;

FIG. 10 illustrates a perspective view of one embodiment of the portable alarm device of the present invention showing the device removed from the base component in accordance with the disclosed architecture;

FIG. 11 illustrates a perspective view of one embodiment of the portable alarm device of the present invention showing the device secured to a cell phone in accordance with the disclosed architecture; and

FIG. 12 illustrates a flowchart showing the method of quickly emitting a personal alarm as needed in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a portable alarm device that provides users with a personal alarm that can be separated from a cell phone and used as an independent device. There is also a long felt need in the art for a portable alarm device that allows a user to carry the alarm in their hand. Further, there is a long felt need in the art for a portable alarm device that can be secured to a cell phone. Moreover, there is a long felt need in the art for a device that can be used as a phone grip to hold a cell phone while in use. Further, there is a long felt need in the art for a portable alarm device that can be used as a kickstand to hold up your cell phone while viewing it. Finally, there is a long felt need in the art for a portable alarm device that is easily recharged, as needed.

The present invention, in one exemplary embodiment, is a novel portable alarm device. The device is a portable alarm which can be secured to a user's cell phone. The portable alarm device comprises a base component that is configured in a rectangular shape with rounded corners. The base component secures to the back of a user's cell phone and acts to accept the back of the grip member component. The grip member component is typically rounded in shape and comprises a rectangular component which mates with the base component and secures the device to a user's cell phone. The grip member component comprises a built-in self-defense alarm and speaker, that is rechargeable via a USB-C charging port, as needed. Further, the grip member device can be expanded to provide a grip and a kickstand. The grip member component can also comprise a pull ring locking mechanism, a pull ring, a safety chain, and an alarm pin to activate the built-in alarm. The present invention also includes a novel method of quickly emitting a personal alarm as needed. The method includes the steps of providing a portable alarm device comprising a base component with a grip member component. The method also comprises securing the base component to a back of a user's cell phone. Further, the method comprises attaching the grip member component to the base component. The method also comprises positioning a user's finger through a pull ring with attached safety chain. Finally, the method comprises pulling off the safety chain via the pull ring to sound the alarm, as needed.

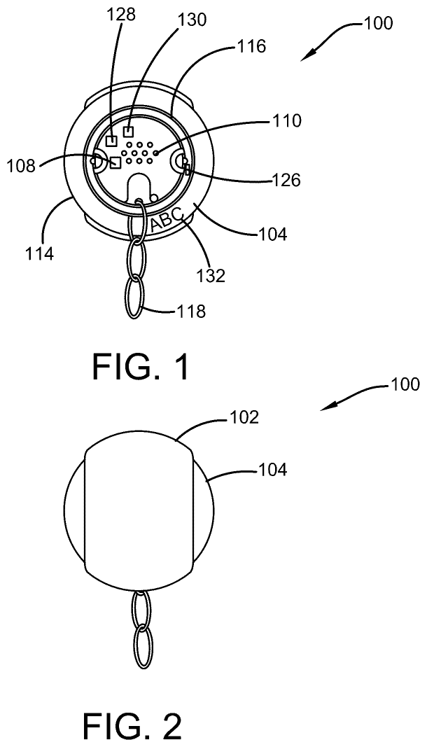

Referring initially to the drawings, FIGS. 1-2 illustrate a perspective view of one embodiment of the portable alarm device 100 of the present invention. In the present embodiment, the portable alarm device 100 is an improved portable alarm device 100 that provides a user with a portable alarm that can be attached to their cell phone 106. Specifically, the portable alarm device 100 comprises a base component 102 and an attached grip member component 104. The grip member component 104 mates with the base component 102 and secures the device 100 to a user's cell phone 106. The grip member component 104 comprises a built-in self-defense alarm 108 and speaker 110, that is rechargeable via a USB-C charging port 112, as needed. The grip member component 104 can also comprise a pull ring locking mechanism 114, a pull ring 116, a safety chain 118, and an alarm pin 120 to activate the built-in alarm 108.

Generally, the portable alarm device 100 is secured to a user's cell phone 106 or detached and used on its own. The portable alarm device 100 allows a user to loop their finger through the pull ring 116, while still being able to operate the cell phone 106 and can read, watch videos, or stream movies on the cell phone 106. If a perpetrator tries to grab the cell phone 106 and run off, the pull ring 116 will be removed from the base component 102 and the alarm will immediately go off. Thus, if a perpetrator tries to grab the cell phone 106 and run off during a “snatch and run robbery”, the pull ring 116 will be removed from the base component 102 and the alarm will immediately go off. Whereas the alarm is attached to the user's cell phone now becomes a property alarm. Thus, the perpetrator is more likely to discard or leave behind user's cell phone 106 instead of continuing to flee with user's property while alarm is going off. As a result, the device 100 not only functions as a personal alarm for a user, but may also function as a property alarm if a cell phone 106 is stolen from a user's hand.

The device 100 can also be operated one-handed from a belt case or car mount for the cell phone 106. Further, the device 100 can be separated from the cell phone 106 and used as an independent device that a user merely carries in their hand.

Furthermore, the portable alarm device 100 comprises a base component 102 that is configured in a rectangular shape with rounded corners but can be any suitable shape as is known in the art. The base component 102 secures to the back 122 of a user's cell phone 106, smart phone, smart pad, etc. Typically, the base component 102 is adhesively mounted with a removable, pressure-sensitive adhesive at a back 122 or rear planar wall of the cell phone 106 or its protective case (not shown). Specifically, the base component 102 is attached to a back panel 122 of a cell phone 106 or other portable electronic device, or to a back panel of a protective and/or ornamental case installed on the electronic device 106. The protective case is optional, as the base component 102 can be secured directly to the cell phone 106, itself. The base component 102 can be any suitable shape and size as is known in the art, as long as the base component 102 acts to secure a grip member component 104 to the cell phone 106 for use. Specifically, the base component 102 comprises indentations or a channel to receive the rectangular part of the grip member component 104. Thus, the rectangular part is slid into or press fit and secured via an interference fit to the base component 102.

Additionally, the portable alarm device 100 comprises a grip member component 104. The grip member component 104 is typically rounded in shape and comprises a rectangular component 124 which mates with the base component 102 and releasably secures the device 100 to a user's cell phone 106, as discussed supra. Further, the rounded part of the grip member component 104 comprises a built-in self-defense alarm 108 and speaker 110, as well as any required circuitry and wiring needed for the alarm 108 and speaker 110. Additionally, the grip member component 104 can be extended outward via an accordion spring or other suitable extending means. This allows a user to use the extended grip member component 104 as a gripping means positioned between their fingers (i.e., similar to a pop socket), or as a kickstand to prop up the cell phone 106 on a table or other surface to watch movies or videos or read from the cell phone 106. Specifically, the kickstand can support the cell phone 106 at an angle against a support surface. In use as a stand, an edge of the cell phone 106 and a portion of the kickstand rest against a support surface supporting the rest of the cell phone 106 above the support surface. Thus, the grip member component 104 in an extended position, can be positioned and dimensioned to support the cell phone 106 in a landscape orientation and/or a portrait orientation.

Further, the grip member component 104 comprises a movable, circular pull ring 116, which is mounted on the grip member component 104 and secured via a pull ring locking mechanism 114. The pull ring locking mechanism 114 would comprise at least one notch 126, which would act to secure the pull ring 116 in place via an interference fit. Specifically, the pull ring 116 is received in a recess of the pull ring locking mechanism 114 and surrounds the center circular part of the grip member component 104. The at least one notch 126 would then act to secure the pull ring 116 in place within the pull ring locking mechanism 114. Further, the at least one notch 126 can be released via a user's finger or nail inserted under the notch 126 to pivot or flip the pull ring 116 free. Once free, the user's finger is then inserted into a central opening of the pull ring 116, so that the pull ring 116 may serve as a holder for the portable alarm device 100 and attached cell phone 106, which also prevents the cell phone 106 from falling out of one's hand or grasp during cell phone 106 use.

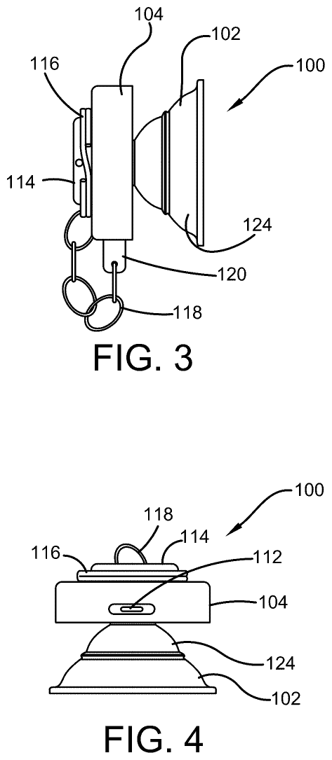

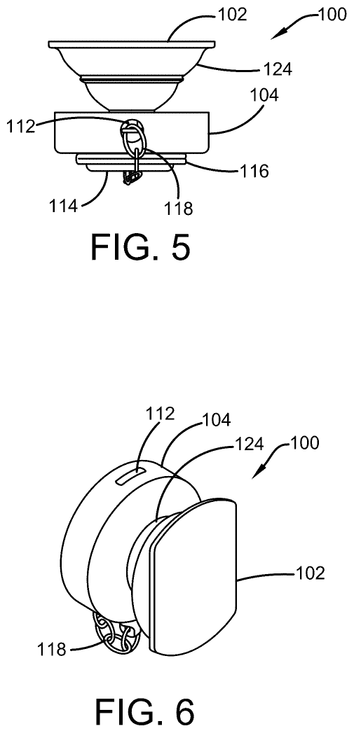

As shown in FIGS. 3-6, the pull ring 116 is secured to a safety chain 118. The safety chain 118 can be any suitable size and length as is known in the art, depending on the needs and/or wants of a user. The safety chain 118 can be secured via a loop. weld, etc., to the pull ring 116. Further, the safety chain 118 can be manufactured of any suitable material, such as rope. twine, wire. chain, etc.

Further, the safety chain 118 is then secured to an alarm pin 120. The alarm pin 120 is communicatively coupled to the speaker 110 and built-in self-defense alarm 108. The user may activate the speaker 110 and alarm 108 by pulling the pull ring 116 away from the device 100, which will remove the alarm pin 120 and sound the alarm 108. Specifically, the alarm pin 120 is a non-conductive component positioned between two conductive components. Thus, once the alarm pin 120 (i.e., the non-conductive component) is removed, the two conductive components are able to touch, which closes the circuit and sounds the alarm 108 through the speakers 110.

Additionally, the rounded part of the grip member component 104 contains a built-in self-defense alarm 108, a rechargeable battery 128, and a speaker 110, which are all electrically interconnected in a common circuit. The rounded part of the grip member component 104 may be configured, in one embodiment, with holes through which the speaker 110 broadcasts a loud alarm sound or siren when the alarm pin 120 is removed and the built-in alarm 108 is actuated. In an emergency, the pull ring 116 may be manually pulled outwardly, which removes the alarm pin 120 to actuate the alarm circuit and immediately sounds the alarm 108. Manually replacing the alarm pin 120 silences the alarm sound or siren.

Furthermore, the rechargeable battery 128 is recharged via an included USB charging port 112. The battery 128 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the portable alarm device 100. Throughout this specification, the term “battery” may be used interchangeably to refer to one or more wet or dry cells or batteries of cells in which chemical energy is converted into electricity and used as a source of DC power. References to recharging or replacing the battery 128 may refer to recharging or replacing individual cells, individual batteries of cells, or a package of multiple battery cells as is appropriate for any given battery technology that may be used. In addition, a rechargeable embodiment of the battery 128 may be recharged using a USB port 112, wherein the USB port 112 is a USB-A, USB-B, Micro-B, Micro-USB, Mini-USB, or USB-C port, etc.

In one embodiment, rather than relying solely on the movement of the pull ring 116, the rounded part of the grip member component 104 may be configured as a button 130 that, when manually pressed. actuates the alarm circuit and, in turn, sounds the alarm 108 through the speaker 110 to cause the loud alarm sound or siren to be generated. Manually pressing on the button 130 again silences the alarm sound or siren.

In other embodiments, the portable alarm device 100 can have another shape. The portable alarm device 100 can also include decorative elements, designs, patterns, etc.

In yet another embodiment, the portable alarm device 100 comprises a plurality of indicia 132. The grip member component 104 of the device 100 may include advertising, a trademark, or other letters, designs, or characters, printed, painted, stamped, or integrated into the grip member component 104, or any other indicia 132 as is known in the art. Specifically, any suitable indicia 132 as is known in the art can be included, such as but not limited to, patterns, logos, emblems, images, symbols, designs, letters, words, characters, animals, advertisements, brands, etc., that may or may not be cell phone, alarm, or brand related.

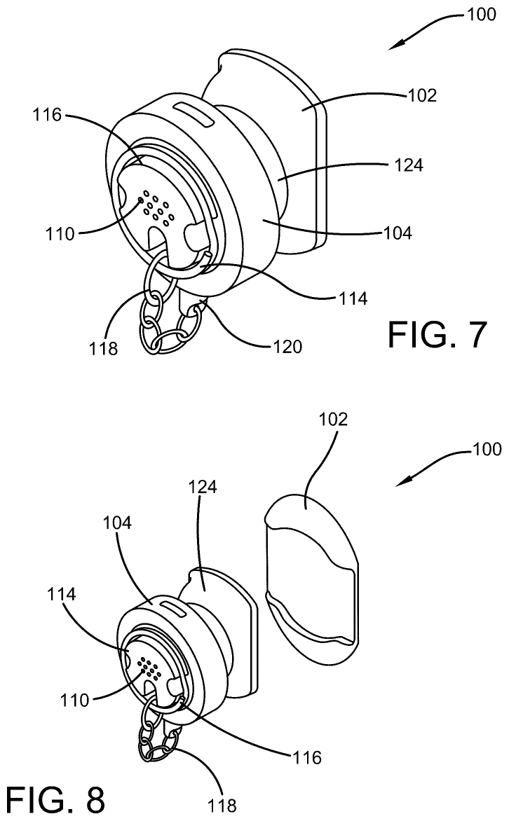

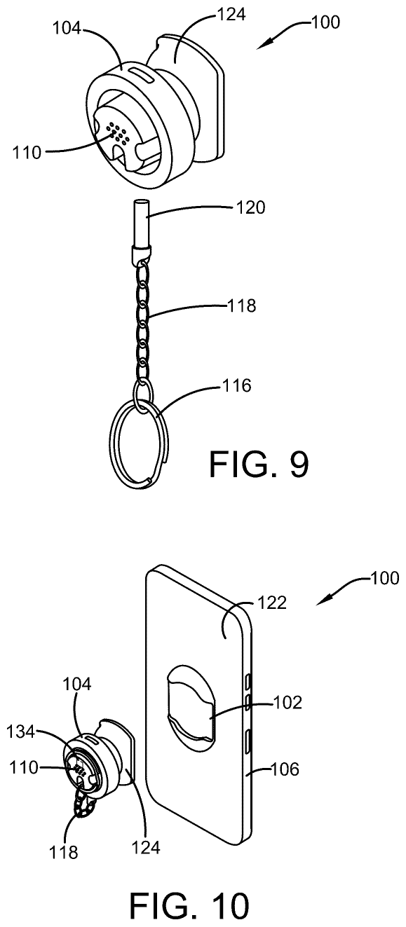

As shown in FIGS. 7-9, thus, in accordance with this disclosure, the response time for actuating the portable alarm device 100 is minimized, because the user's finger is already normally located within the pull ring 116 during cell phone 106 use, and there is a little or negligible time delay in actuating the alarm circuit by the user pulling the pull ring 106 and removing the alarm pin 120, or pressing a button 130 on the grip member component 104. in an emergency.

As shown in FIG. 10, the grip member component 104 is detachable from the base component 102 and functions on its own. A user merely holds the device 100 within their hand and either pulls the pull ring 116 to remove the alarm pin 120 or manually presses the alarm button 130.

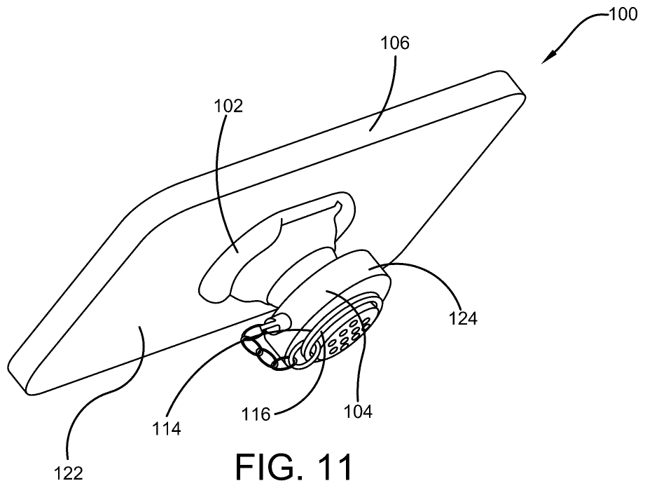

As shown in FIG. 11, the portable alarm device 100 can be used with portable electronic devices other than a cell phone 106, such as tablet computers or e-readers, etc.

Rather than relying solely on the loud siren to draw attention to the user in the event of an emergency, i.e., a medical emergency or a physical attack, the alarm circuit advantageously includes a Bluetooth transceiver 134 to wirelessly communicate with the cell phone's on-board microprocessor or controller and, in turn, with the cell phone's on-board memory. Thus, actuating the alarm circuit by pulling on the pull ring 116 and removing the alarm pin 120, as described above, generates an electrical alarm signal that automatically wirelessly communicates with the cell phone's controller and activates an auto-dial call to e-911 (enhanced 911) to notify law enforcement, medical personnel, and/or to any pre-designated individuals or responders whose contact numbers have been entered into and stored in the cell phone's memory. The auto-dial feature need not be accompanied with a loud siren, because, in some emergency situations, it may be desirable just to generate a silent alarm.

In use, the portable alarm device 100 is secured to the back 122 of a user's cell phone 106 and a user disengages the pull ring 116 from the grip member component 104 and inserts one or more fingers through the pull ring 116 to securely hold the cell phone 106 and device 100 for use. Thus, if the user's cell phone 106 is taken, the pull ring 116 around a user's finger pulls the safety chain 118 to remove the alarm pin 120 and sound the alarm 108.

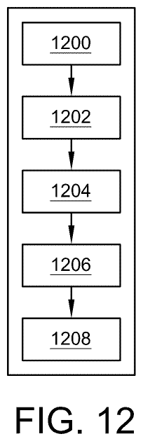

FIG. 12 illustrates a flowchart of the method of quickly emitting a personal alarm as needed. The method includes the steps of at 1200, providing a portable alarm device comprising a base component with a grip member component. The method also comprises at 1202, securing the base component to a back of a user's cell phone. Further, the method comprises at 1204, attaching the grip member component to the base component. The method also comprises at 1206, positioning a user's finger through a pull ring with attached safety chain. Finally, the method comprises at 1208, pulling off the safety chain via the pull ring to sound the alarm, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “portable alarm device”, “alarm device”, “portable device”, and “device” are interchangeable and refer to the portable alarm device 100 of the present invention.

Notwithstanding the forgoing, the portable alarm device 100 of the present invention can be of any suitable size and configuration as is known in the art without affecting the overall concept of the invention, provided that it accomplishes the above stated objectives. One of ordinary skill in the art will appreciate that the portable alarm device 100 as shown in FIGS. 1-12 is for illustrative purposes only, and that many other sizes and shapes of the portable alarm device 100 are well within the scope of the present disclosure. Although the dimensions of the portable alarm device 100 are important design parameters for user convenience, the portable alarm device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable alarm device that provides a user with a portable alarm for a cell phone, the portable alarm device comprising:
a base component; and
a grip member component;
wherein the base component is secured to a back of a cell phone;
wherein the grip member component is secured to the base component;
wherein the grip member component comprises a built-in alarm and speaker; and
further wherein the built-in alarm is triggered via removal of an alarm pin.

2. The portable alarm device of claim 1, wherein the base component is configured in a rectangular shape with rounded corners and secures to the back of the cell phone via a removable, pressure-sensitive adhesive.

3. The portable alarm device of claim 1, wherein the base component is secured to a back of a cell phone's protective case.

4. The portable alarm device of claim 2, wherein the grip member component comprises a rectangular component which is press fit within the base component.

5. The portable alarm device of claim 4, wherein the grip member component can be extended outward and utilized as a gripping means positioned between a user's fingers or as a kickstand to prop up the cell phone.

6. The portable alarm device of claim 5, wherein the grip member component comprises a pull ring secured via a pull ring locking mechanism.

7. The portable alarm device of claim 6, wherein the pull ring locking mechanism comprises at least one notch, which would act to secure the pull ring in place via an interference fit.

8. The portable alarm device of claim 7, wherein a user's finger is then inserted into a central opening of the pull ring, so that the pull ring may serve as a holder for the portable alarm device and attached cell phone.

9. The portable alarm device of claim 8, wherein the pull ring is secured to a safety chain.

10. The portable alarm device of claim 9, wherein the safety chain is then secured to an alarm pin, wherein the alarm pin is communicatively coupled to the speaker and built-in alarm, such that a user may activate the speaker and the built-in alarm by pulling the pull ring away from the portable alarm device, which will remove the alarm pin and sound the built-in alarm.

11. The portable alarm device of claim 10, wherein the pull ring may be manually pulled outwardly, which removes the alarm pin to actuate alarm circuit and immediately sounds the built-in alarm and manually replacing the alarm pin silences alarm sound.

12. The portable alarm device of claim 11 further comprising a rechargeable battery which is recharged via an included USB charging port.

13. A portable alarm device that provides a user with a portable alarm for a cell phone, the portable alarm device comprising:
a base component secured to a back of a cell phone via a removable, pressure-sensitive adhesive; and
a grip member component which comprises a rectangular component which is press fit within the base component;
wherein the grip member component can be extended outward and utilized as a gripping means positioned between a user's fingers or as a kickstand to prop up the cell phone;
wherein the grip member component comprises a built-in alarm and speaker;
wherein the grip member component comprises a pull ring secured via a pull ring locking mechanism;
wherein the pull ring locking mechanism comprises at least one notch, which would act to secure the pull ring in place via an interference fit;
wherein a user's finger is then inserted into a central opening of the pull ring, so that the pull ring may serve as a holder for the portable alarm device and attached cell phone;
wherein the pull ring is secured to a safety chain;
wherein the safety chain is then secured to an alarm pin, wherein the alarm pin is communicatively coupled to the speaker and the built-in alarm, such that a user may activate the speaker and the built-in alarm by pulling the pull ring away from the portable alarm device, which will remove the alarm pin and sound the built-in alarm; and
further wherein the grip member component comprises a rechargeable battery which is recharged via an included USB charging port.

14. The portable alarm device of claim 13, wherein rather than relying solely on movement of the pull ring, the grip member component comprises a button that, when manually pressed, actuates alarm circuit and sounds the built-in alarm through the speaker.

15. The portable alarm device of claim 14, wherein manually pressing on the button again silences alarm sound.

16. The portable alarm device of claim 13 further comprising a plurality of indicia.

17. The portable alarm device of claim 13 wherein the grip member component is detachable from the base component and functions on its own.

18. The portable alarm device of claim 13 wherein the portable alarm device can be used with portable electronic devices other than a cell phone, such as tablet computers or e-readers.

19. The portable alarm device of claim 13 wherein the grip member component comprises a Bluetooth transceiver to wirelessly communicate with cell phone's on-board microprocessor and on-board memory, thus automatically wirelessly communicating to auto-dial e-911.

20. A method of quickly emitting a personal alarm as needed, the method comprising the following steps:
providing a portable alarm device comprising a base component with a grip member component;
securing the base component to a back of a user's cell phone;
attaching the grip member component to the base component;
positioning a user's finger through a pull ring with attached safety chain; and
pulling off the safety chain via the pull ring to sound the alarm, as needed.
